(19) United States
(12) Patent Application Publication
(10) Pub. No.: US 2022/0315692 A1
(43) Pub. Date: Oct. 6, 2022

(54) WATERBORNE POLYURETHANE

(71) Applicant: Industrial Technology Research Institute, Hsinchu (TW)

(72) Inventors: Ying-Chen Liao, Hsinchu County (TW); Hsu-Tzu Fan, Hualien County (TW)

(73) Assignee: Industrial Technology Research Institute, Hsinchu (TW)

(21) Appl. No.: 17/399,059

(22) Filed: Aug. 11, 2021

(30) Foreign Application Priority Data
Apr. 1, 2021 (TW) 110112216

(51) Int. Cl. C08G 18/75; C08G 18/42; C08G 18/48; C08G 18/34; C08G 18/66; C08G 18/40

(52) U.S. Cl. CPC C08G 18/755; C08G 18/423; C08G 18/4854; C08G 18/348; C08G 18/6692; C08G 18/4018

(57) ABSTRACT

Provided is a waterborne polyurethane obtained by polymerizing an alicyclic polyester polyol, a diisocyanate, and a hydrophilic chain extender. The alicyclic polyester polyol includes an alicyclic polyester polyol having a four-membered ring and/or an alicyclic polyester polyol having a six-membered ring. Based on a usage amount of 1 part by weight of the alicyclic polyester polyol having a four-membered ring and/or a six-membered ring, a usage amount of the diisocyanate is between 0.3 parts by weight and 12 parts by weight, and a usage amount of the hydrophilic chain extender is between 0.05 parts by weight and 1.5 parts by weight.

### CROSS-REFERENCE TO RELATED APPLICATION

This application claims the priority benefit of Taiwan application serial no. 110112216, filed on Apr. 1, 2021. The entirety of the above-mentioned patent application is hereby incorporated by reference herein and made a part of this specification.

### TECHNICAL FIELD

The disclosure relates to a waterborne polyurethane.

### BACKGROUND

Polyurethane (PU) is widely used in industrial fields, and application products thereof include adhesives, and surface coating of various objects, etc. However, a large amount of organic solvents is needed when using polyurethane, resulting in serious environmental pollution. Based on the consideration of environmental protection, the waterborne process of polyurethane has become a development trend.

In the waterborne polyurethane production process, polyester polyol is mostly used as raw material. However, since the ester group in the structure of polyester polyol is readily hydrolyzed, polyester polyol is degraded from high molecular weight to low molecular weight. Therefore, the storage stability of the resulting product is shortened.

### SUMMARY

The disclosure provides a waterborne polyurethane obtained by polymerizing an alicyclic polyester polyol, a diisocyanate, and a hydrophilic chain extender, and the alicyclic polyester polyol includes an alicyclic polyester polyol having a four-membered ring and/or a six-membered ring.

According to embodiments of the disclosure, the waterborne polyurethane is obtained by polymerizing an alicyclic polyester polyol, a diisocyanate, and a hydrophilic chain extender. The alicyclic polyester polyol includes an alicyclic polyester polyol having a four-membered ring and/or an alicyclic polyester polyol having a six-membered ring. Based on a usage amount of 1 part by weight of the alicyclic polyester polyol having a four-membered ring and/or a six-membered ring, a usage amount of the diisocyanate is between 0.3 parts by weight and 12 parts by weight, and a usage amount of the hydrophilic chain extender is between 0.05 parts by weight and 1.5 parts by weight.

Several exemplary embodiments are described in detail below to further describe the disclosure in details.

### DETAILED DESCRIPTION

Terms such as “contain”, “include”, and “have” used in the specification are all open terms, i.e., “contains, but not limited to”.

In addition, in the present specification, a range represented by “a numerical value to another numerical value” is a schematic representation for avoiding listing all of the numerical values in the range in the specification. Therefore, the description of a specific numerical range covers any numerical value within the numerical range and a smaller numerical range defined by any numerical value within the numerical range.

A waterborne polyurethane of an embodiment of the disclosure is obtained by polymerizing an alicyclic polyester polyol, a diisocyanate, and a hydrophilic chain extender, and the alicyclic polyester polyol includes an alicyclic polyester polyol having a four-membered ring and/or an alicyclic polyester polyol having a six-membered ring. Structurally, an ester group may be protected from hydrolysis by the steric barrier of an alicyclic ring to prevent the polyester polyol from degrading from high molecular weight to low molecular weight. In this way, the waterborne polyurethane of an embodiment of the disclosure may have better resistance toward hydrolysis. In addition, the waterborne polyurethane of an embodiment of the disclosure also may have higher elongation. Hereinafter, the waterborne polyurethane of an embodiment of the disclosure is described in detail.

According to an embodiment of the disclosure, the waterborne polyurethane is formed by mixing an alicyclic polyester polyol, a diisocyanate, and a hydrophilic chain extender into a mixture, and subjecting the mixture to a polymerization reaction. During mixing, based on a usage amount of 1 part by weight of the alicyclic polyester polyol, the usage amount of the diisocyanate is between 0.3 parts by weight and 12 parts by weight, and the usage amount of the hydrophilic chain extender is between 0.05 parts by weight and 1.5 parts by weight.

In an embodiment, the preparation method of the waterborne polyurethane may include the following steps. First, the alicyclic polyester polyol is dehydrated under reduced pressure at a temperature of 95° C. to 105° C. for 1 hour to 2 hours. Then, the temperature is lowered to 40° C. to 60° C., and the diisocyanate is added to react at a temperature of 70° C. to 90° C. for 1 hour to 4 hours until the NCO % of the prepolymer reaches a set value. Then, a neutralizer (for example, triethanolamine, triethylamine, or a combination thereof) is added to react at a temperature of 30° C. to 60° C. for 10 minutes to 15 minutes. Next, under high-speed stirring, the resulting polymer is added with deionized water for emulsification and dispersion. Then, the hydrophilic chain extender is added to react at room temperature for 2 hours to 4 hours to obtain the waterborne polyurethane of an embodiment of the disclosure.

Alicyclic Polyester Polyol

In an embodiment of the disclosure, the alicyclic polyester polyol includes an alicyclic polyester polyol having a four-membered ring and/or an alicyclic polyester polyol having a six-membered ring. In an embodiment, the alicyclic polyester polyol is formed by the reaction of an alicyclic diol and a dibasic acid, wherein the molar ratio of the functional groups of the alicyclic diol to the dibasic acid (OH:COOH), for example, is between 1.1:1 and 1.8:1.

The alicyclic diol includes a cyclobutanediol-based compound that is, for example, 2,2,4,4-tetramethyl-1,3-cyclobutanediol (CBDO). The dibasic acid is, for example, adipic acid, sebacic acid, terephthalic acid, isophthalic acid, or a combination thereof. In an embodiment, the preparation method of the alicyclic polyester polyol may include the following steps. First, in the presence of a catalyst (such as an organometallic catalyst, an acid catalyst, or an alkaline catalyst), the alicyclic diol and the dibasic acid are reacted at a temperature of 150° C. to 200° C. until an initial polyester is produced. Then, the initial polyester is heated at a temperature of 200° C. to 250° C. for 3 hours to 12 hours, until the acid value is less than a set value. Next, vacuuming under reduced pressure is performed for 1 hour to 4 hours to remove unreacted diols to obtain the polyester polyol. The hydroxyl value of the resulting polyester polyol is between 30 mg KOH/g and 224 mg KOH/g.

Moreover, in another embodiment, the alicyclic diol used in the preparation of the alicyclic polyester polyol may include a cyclohexanedimethanol-based compound in addition to the cyclobutanediol-based compound. The cyclohexanedimethanol-based compound is, for example, 1,4-cyclohexanedimethanol (CHDM). In other words, the alicyclic diol used in the preparation of the alicyclic polyester polyol includes both the cyclobutanediol-based compound and the cyclohexanedimethanol-based compound.

Based on the above, in an embodiment, the alicyclic polyester polyol used may be represented by Chemical formula 1, wherein 0≤X≤1, and n is between 1 and 10.

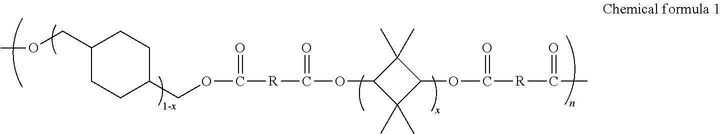

In Chemical formula 1, when X is 1, the alicyclic polyester polyol has a four-membered ring structure. In other words, the cyclobutanediol-based compound is used to react with the dibasic acid when preparing the alicyclic polyester polyol. In addition, when X is not 1, the alicyclic polyester polyol has both a four-membered ring structure and a six-membered ring structure. In other words, in the preparation of the alicyclic polyester polyol, the cyclobutanediol-based compound and the cyclohexanedimethanol-based compound are used together to react with the dibasic acid. In addition, when X is 0, the alicyclic polyester polyol has a six-membered ring structure. In other words, the cyclohexanedimethanol-based compound is used to react with the dibasic acid when preparing the alicyclic polyester polyol. However, the alicyclic polyester polyol of an embodiment of the disclosure is not limited to the structure represented by Chemical formula 1.

Diisocyanate

In an embodiment of the disclosure, the diisocyanate may be an aromatic diisocyanate, an aliphatic diisocyanate, an alicyclic diisocyanate, or a combination thereof.

The aromatic diisocyanate is, for example, toluene diisocyanate (TDI), p-phenylene diisocyanate (PPDI), 4,4′-diphenylmethane diisocyanate (MDI), p,p′-bisphenyl diisocyanate (BPDI), or a combination thereof.

The aliphatic diisocyanate is, for example, hexamethylene diisocyanate (HDI), trimethylhexamethylene diisocyanate (TMDI), or a combination thereof.

The alicyclic diisocyanate is, for example, isophorone diisocyanate (IPDI), 4,4′-methylene dicyclohexyl diisocyanate (H12MDI), or a combination thereof.

In the process of preparing the waterborne polyurethane of an embodiment of the disclosure, based on a usage amount of 1 part by weight of the alicyclic polyester polyol, the usage amount of the diisocyanate is between 0.3 parts by weight and 12 parts by weight.

Hydrophilic Chain Extender

In an embodiment of the disclosure, the hydrophilic chain extender may be a carboxylic-based hydrophilic chain extender, a sulfonic-based hydrophilic chain extender, an amine-based hydrophilic chain extender, or a combination thereof.

The carboxylic-based hydrophilic chain extender is, for example, dimethylolpropionic acid (DMPA), dimethylolbutanoic acid (DMBA), or a combination thereof.

The sulfonic-based hydrophilic chain extender is, for example, N-(2-aminoethyl)-2-amino sodium ethyl sulfonate (AAS), sodium 1,2-dihydroxy-3-propanesulfonate (DHPA), or a combination thereof.

The amine-based hydrophilic chain extender is, for example, ethylenediamine, diethylenetriamine, triethylenetetramine, or a combination thereof.

In the process of preparing the waterborne polyurethane of an embodiment of the disclosure, based on a usage amount of 1 part by weight of the alicyclic polyester polyol, the usage amount of the hydrophilic chain extender is between 0.05 parts by weight and 1.5 parts by weight. When the usage amount of the hydrophilic chain extender is less than 0.05 parts by weight, emulsification and dispersion may not be effectively performed. When the usage amount of the hydrophilic chain extender is more than 1.5 parts by weight, the phenomenon of hydrophilic swelling is likely to occur and cause coagulation.

Moreover, in the preparation process of the waterborne polyurethane of an embodiment of the disclosure, in addition to the use of the alicyclic polyester polyol, the diisocyanate, and the hydrophilic chain extender for polymerization, other types of polyols may also be additionally added. The other types of polyols may be an aliphatic polyester polyol or a polyether polyol. The aliphatic polyester polyol is, for example, poly(1,4-butylene adipate), polyethylene adipate glycol, polycaprolactone polyol, polycarbonate diol, or a combination thereof. The polyether polyol is, for example, polytetramethylene ether glycol (PTMEG), polyethylene glycol, polypropylene glycol, or a combination thereof. In the process of preparing the waterborne polyurethane of an embodiment of the disclosure, based on a usage amount of 1 part by weight of the alicyclic polyester polyol, the usage amount of the other types of polyols is, for example, between 0.5 parts by weight and 20 parts by weight.

Hereinafter, Experimental examples and Comparative examples are used to describe the hydrolysis resistance and the elongation of the waterborne polyurethane in an embodiment of the disclosure.

### Experimental Example 1

175.36 g of adipic acid, 242.28 g of CBDO, and 0.25 g of a tin catalyst (model T-12, Alfa Aesar) were added to a 0.5 L four-necked glass reaction flask. After heating to 150° C. to fusion, nitrogen gas was introduced and the reaction mixture was gradually heated to 230° C. to perform a polycondensation reaction for 3 hours to 6 hours to obtain alicyclic polyester polyol PES-002 (acid value 1.9 mgKOH/g, hydroxyl value 57.3 mgKOH/g).

1 part by weight of alicyclic polyester polyol (PES-002), 2.65 parts by weight of diisocyanate (IPDI), 0.34 parts by weight of a hydrophilic chain extender (DMBA), and 3.99 parts by weight of polyether polyol (PTMEG) (model PTG, Dairen Chemical Corporation) were mixed to perform a polymerization reaction to form waterborne polyurethane.

### Experimental Example 2

1 part by weight of alicyclic polyester polyol (PES-002), 1.76 parts by weight of diisocyanate (IPDI), 0.22 parts by weight of a hydrophilic chain extender (DMPA), and 2.79 parts by weight of polyether polyol (PTMEG) (model PTG, Dairen Chemical Corporation) were mixed to perform a polymerization reaction to form waterborne polyurethane.

### Experimental Example 3

1 part by weight of alicyclic polyester polyol (PES-002), 0.60 parts by weight of diisocyanate (IPDI), 0.10 parts by weight of a hydrophilic chain extender (DMBA), and 0.76 parts by weight of polyether polyol (PTMEG) (model PTG, Dairen Chemical Corporation) were mixed to perform a polymerization reaction to form waterborne polyurethane.

### Experimental Example 4

1 part by weight of alicyclic polyester polyol (PES-002), 4.92 parts by weight of diisocyanate (IPDI), 0.60 parts by weight of a hydrophilic chain extender (DMPA), and 9.17 parts by weight of polyether polyol (PTMEG) (model PTG, Dairen Chemical Corporation) were mixed to perform a polymerization reaction to form waterborne polyurethane.

### Experimental Example 5

1 part by weight of alicyclic polyester polyol (PES-002), 0.85 parts by weight of diisocyanate (IPDI), 0.13 parts by weight of a hydrophilic chain extender (DMBA), and 1.00 part by weight of aliphatic polyester polyol (PBA) were mixed to perform a polymerization reaction to form waterborne polyurethane.

### Experimental Example 6

160.75 g of adipic acid, 111.04 g of CBDO, 111.04 g of CHDM, and 0.23 g of a tin catalyst (model T-12, Alfa Aesar) were added to a 0.5 L four-necked glass reaction flask. After heating to 150° C. to fusion, nitrogen gas was introduced and the temperature of the reaction mixture was increased to 230° C. to perform a polycondensation reaction for 3 hours to 6 hours to obtain alicyclic polyester polyol PES-004 (acid value 1.0 mgKOH/g, hydroxyl value 39.3 mgKOH/g).

1 part by weight of alicyclic polyester polyol (PES-004), 2.38 parts by weight of diisocyanate (IPDI), 0.34 parts by weight of a hydrophilic chain extender (DMBA), and 4.28 parts by weight of polyether polyol (PTMEG) (model PTG, Dairen Chemical Corporation) were mixed to perform a polymerization reaction to form waterborne polyurethane.

### Experimental Example 7

1 part by weight of alicyclic polyester polyol (PES-004), 1.11 parts by weight of diisocyanate (IPDI), 0.15 parts by weight of a hydrophilic chain extender (DMPA), and 1.67 parts by weight of polyether polyol (PTMEG) (model PTG, Dairen Chemical Corporation) were mixed to perform a polymerization reaction to form waterborne polyurethane.

### Experimental Example 8

160.75 g of adipic acid, 111.04 g of CBDO, 111.04 g of CHDM, and 0.23 g of a tin catalyst (model T-12, Alfa Aesar) were added to a 0.5 L four-necked glass reaction flask. After heating to 150° C. to fusion, nitrogen gas was introduced and the temperature of the reaction mixture was increased to 230° C. to perform a polycondensation reaction for 3 hours to 6 hours to obtain alicyclic polyester polyol PES-006 (acid value 1.0 mgKOH/g, hydroxyl value 39.3 mgKOH/g).

1 part by weight of alicyclic polyester polyol (PES-006), 2.52 parts by weight of diisocyanate (IPDI), 0.34 parts by weight of a hydrophilic chain extender (DMBA), and 4.10 parts by weight of polyether polyol (PTMEG) (model PTG, Dairen Chemical Corporation) were mixed to perform a polymerization reaction to form waterborne polyurethane.

### Experimental Example 9

1 part by weight of alicyclic polyester polyol (PES-002), 4.13 parts by weight of alicyclic polyester polyol (PES-006), 10.73 parts by weight of diisocyanate (IPDI), 1.32 parts by weight of a hydrophilic chain extender (DMBA), and 16.96 parts by weight of polyether polyol (PTMEG) (model PTG, Dairen Chemical Corporation) were mixed to perform a polymerization reaction to form waterborne polyurethane.

### Comparative Example 1

1 part by weight of aliphatic polyester polyol (PBA), 0.64 parts by weight of diisocyanate (IPDI), and 0.08 parts by weight of a hydrophilic chain extender (DMBA) were mixed to perform a polymerization reaction to form waterborne polyurethane.

### Comparative Example 2

1 part by weight of polyether polyol (PTMEG), 0.64 parts by weight of diisocyanate (IPDI), and 0.08 parts by weight of a hydrophilic chain extender (DMBA) were mixed to perform a polymerization reaction to form waterborne polyurethane.

### Comparative Example 3

1 part by weight of polyether polyol (PTMEG), 0.65 parts by weight of diisocyanate (IPDI), 0.08 parts by weight of a hydrophilic chain extender (DMBA), and 0.25 parts by weight of polycarbonate polyol (PCDL) (model: CPX-2012-112, Aramco Chemicals) were mixed to perform a polymerization reaction to form waterborne polyurethane.

### Comparative Example 4

1 part by weight of polyether polyol (PTMEG), 1.03 parts by weight of diisocyanate (IPDI), 0.13 parts by weight of a hydrophilic chain extender (DMBA), and 1 part by weight of aliphatic polyester polyol (PBA) (model: AR-U2420, Yong Shun Chemical Co. Ltd.) were mixed to perform a polymerization reaction to form waterborne polyurethane.

A hydrolysis resistance test and an elongation test were performed on the waterborne polyurethanes of the Experimental examples and the Comparative examples. The results are shown in Table 1.

Hydrolysis Resistance Test

The tensile strength retention after 7 days at a temperature of 70° C. and a relative humidity of 95% RH was measured.

Elongation Test

The test piece was cut into a dumbbell shape with a cutter (ASTM D-412 C), and the tensile speed of the movement of the chuck was set to 500 mm/min using a tensile machine for testing.

TABLE 1

| | Tensile strength retention (%) | Elongation (%) |
|---|---|---|
| Experimental example 1 | 86.8 | 407 |
| Experimental example 2 | 70.4 | 431 |
| Experimental example 3 | 73.5 | 433 |
| Experimental example 4 | 71.6 | 438 |
| Experimental example 5 | 80.3 | 470 |
| Experimental example 6 | 80.2 | 488 |
| Experimental example 7 | 83.6 | 450 |
| Experimental example 8 | 70.0 | 406 |
| Experimental example 9 | 73.0 | 402 |
| Comparative example 1 | 0 | 325 |
| Comparative example 2 | 88.7 | 325 |
| Comparative example 3 | 60.1 | 383 |
| Comparative example 4 | 30.6 | 380 |

It may be clearly seen from Table 1 that the waterborne polyurethanes of the embodiments of the disclosure may simultaneously have better hydrolysis resistance and higher elongation. In addition, although the waterborne polyurethane of Comparative example 2 has high hydrolysis resistance, good elongation was not achieved at the same time.

It will be apparent to those skilled in the art that various modifications and variations may be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A waterborne polyurethane, wherein the waterborne polyurethane is obtained by polymerizing an alicyclic polyester polyol, a diisocyanate, and a hydrophilic chain extender, wherein the alicyclic polyester polyol comprises an alicyclic polyester polyol having a four-membered ring and/or an alicyclic polyester polyol having a six-membered ring, and based on a usage amount of 1 part by weight of the alicyclic polyester polyol having a four-membered ring and/or a six-membered ring, a usage amount of the diisocyanate is between 0.3 parts by weight and 12 parts by weight, and a usage amount of the hydrophilic chain extender is between 0.05 parts by weight and 1.5 parts by weight.

2. The waterborne polyurethane of claim 1, wherein the alicyclic polyester polyol having the four-membered ring and/or an alicyclic polyester polyol having the six-membered ring is represented by Chemical formula 1, 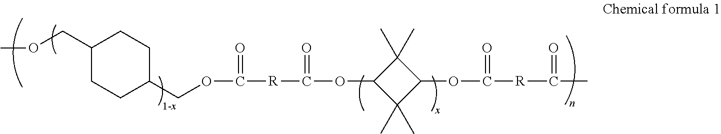
in Chemical formula 1, 0≤X≤1, and n is between 1 and 10.

3. The waterborne polyurethane of claim 1, wherein the diisocyanate comprises an aromatic diisocyanate, an aliphatic diisocyanate, an alicyclic diisocyanate, or a combination thereof.

4. The waterborne polyurethane of claim 3, wherein the aromatic diisocyanate comprises toluene diisocyanate, p-phenyl diisocyanate, 4,4′-diphenylmethane diisocyanate, p,p′-diphenyl diisocyanate, or a combination thereof.

5. The waterborne polyurethane of claim 3, wherein the aliphatic diisocyanate comprises hexamethylene diisocyanate, trimethyl hexamethylene diisocyanate, or a combination thereof.

6. The waterborne polyurethane of claim 3, wherein the alicyclic diisocyanate comprises isophorone diisocyanate, dicyclohexyl 4,4′-methane diisocyanate, or a combination thereof.

7. The waterborne polyurethane of claim 1, wherein the hydrophilic chain extender comprises a carboxylic-based hydrophilic chain extender, a sulfonic-based hydrophilic chain extender, an amine-based hydrophilic chain extender, or a combination thereof.

8. The waterborne polyurethane of claim 7, wherein the hydrophilic chain extender comprises dimethylolpropionic acid, dimethylolbutyric acid, N-(2-aminoethyl)-2-amino sodium ethyl sulfonate, sodium 1,2-dihydroxy-3-propanesulfonate, ethylenediamine, diethylenetriamine, triethylenetetramine, or a combination thereof.

9. The waterborne polyurethane of claim 1, wherein the waterborne polyurethane is obtained by polymerizing the alicyclic polyester polyol, the diisocyanate, the hydrophilic chain extender, and additional polyols, and the additional polyols comprise polyether polyol, aliphatic polyester polyol, or a combination thereof.

10. The waterborne polyurethane of claim 9, wherein the polyether polyol comprises polytetramethylene ether glycol, polyethylene glycol, polypropylene glycol, or a combination thereof.
